(19) United States
(12) Patent Application Publication
(10) Pub. No.: US 2012/0052266 A1
(43) Pub. Date: Mar. 1, 2012

(54) Oleophobic Membrane Including A Printed Patterned Layer of Particles and Method

(76) Inventor: YitHong Tee, Lee's Summit, MO (US)

(21) Appl. No.: 12/868,247

(22) Filed: Aug. 25, 2010

(51) Int. Cl. B32B 3/10; B41F 33/00; B05D 1/36

(52) U.S. Cl. 428/206; 427/202; 427/205; 101/483

(57) ABSTRACT

A method of making a membrane structure includes, in an exemplary embodiment, providing an air permeable hydrophobic membrane having a first side and a second side, coating the hydrophobic membrane with a fluoropolymer to impart oleophobic properties to the hydrophobic membrane, and printing a patterned layer of particles onto the first side of the hydrophobic membrane.

### BACKGROUND OF THE INVENTION

The field of the invention relates generally to composite porous membranes, and more particularly to composite porous membranes having oleophobic properties and a discontinuous patterned layer of particles printed onto the porous membranes.

It is known that a porous membrane may have at least one property that is limited by the material that the membrane is made from. For example, a porous membrane made from an expanded polytetrafluoroethylene (ePTFE) material that is intended for use in garments and apparel has excellent hydrophobicity so it is considered to be waterproof at a relatively low challenge pressure. However, the ePTFE membrane tends to absorb oil. Such a tendency to absorb oil could affect the hydrophobicity in the area of the membrane that has absorbed the oil so that area of the membrane may no longer be considered waterproof.

One known way to protect an ePTFE membrane from contamination by oil utilizes a continuous hydrophilic film attached to the ePTFE membrane to protect one side of the ePTFE membrane from oil. This structure is not air permeable and the hydrophilic film must contain moisture to transmit the moisture through the membrane. A heavier garment results from the necessary moisture present in the hydrophilic film. A person wearing a garment incorporating the membrane with the hydrophilic film often can feel uncomfortable because the hydrophilic film that contains moisture contacts the wearer's body, especially in cool environments. Such discomfort has been described as a “wet and clammy” feeling. This discomfort may be further aggravated by a lack of air moving through the garment that could serve to carry the moisture away from inside the garment.

### BRIEF DESCRIPTION OF THE INVENTION

In one aspect, a method of making a membrane structure is provided. The method includes providing an air permeable hydrophobic membrane having a first side and a second side, coating the membrane with a fluoropolymer to impart oleophobic properties to the membrane, and printing a patterned layer of particles onto the first side of the membrane.

In another aspect, a membrane structure is provided. The membrane structure includes an air permeable hydrophobic membrane having a first side and a second side, and a coating applied to the surfaces of the membrane. The coating includes a fluoropolymer that has oleophobic properties. The membrane structure further includes a patterned layer of particles applied onto the first side of the membrane.

In another aspect, a garment having a first layer and a second layer is provided. The first layer includes a fabric, and the second layer includes an air permeable hydrophobic membrane having a first side and a second side, and a coating applied to the surfaces of the membrane. The coating includes a fluoropolymer and has oleophobic properties. The second layer further includes a patterned layer of particles printed onto the first side of the membrane.

### BRIEF DESCRIPTION OF THE DRAWINGS

FIG. 1 is an enlarged schematic illustration of a portion of a membrane treated according to an embodiment of the present invention.

FIG. 2 is an enlarged sectional view of a portion of the membrane in FIG. 1 illustrating a coating on the membrane.

FIG. 3 is an enlarged view of a discontinuous patterned layer applied to the membrane.

FIG. 4 is an enlarged end view of the membrane shown in FIG. 3.

### DETAILED DESCRIPTION OF THE INVENTION

A composite membrane structure having oleophobic properties and a discontinuous patterned layer of particles printed onto the porous membranes, and a method of making the composite membrane are described below in detail. The composite membrane includes, in an exemplary embodiment, an air permeable hydrophobic membrane having a plurality of pores and a coating applied to the membrane. The coating has oleophobic properties and is deposited onto the membrane without blocking the pores of the membrane. The composite membrane provides a combination of functionalities including air permeable, waterproof, breathable, oleophobic, and enhanced durability properties over known membranes.

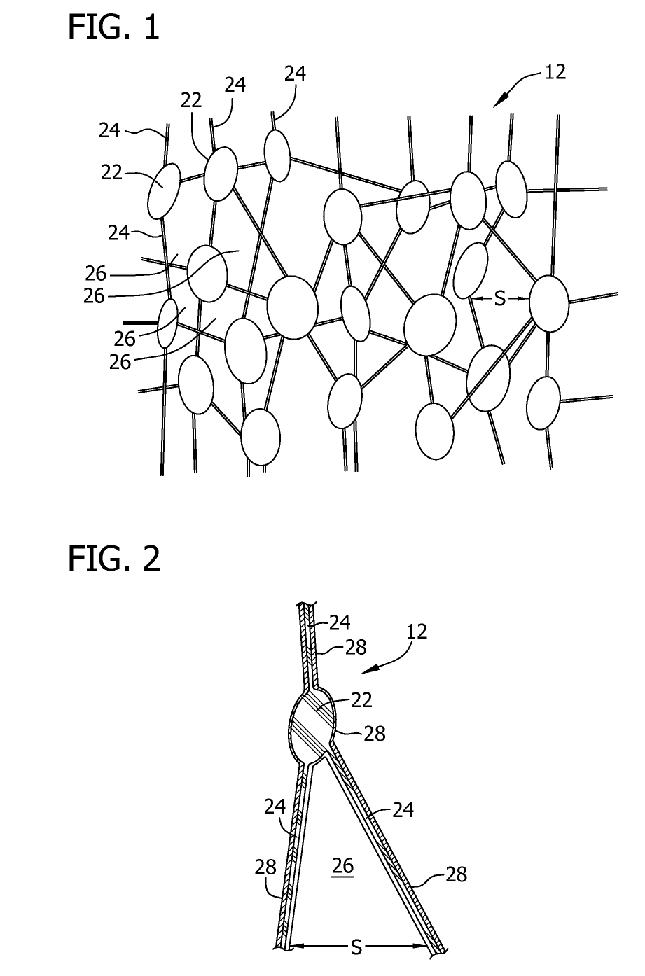

FIG. 1 is a schematic illustration of an exemplary embodiment of a composite membrane structure 12 that can be used in garments or apparel. Composite membrane structure 12 is wind resistant, waterproof, moisture vapor transmission and air permeable. Composite membrane structure 12 is hydrophobic and oleophobic and offers protection from contaminating agents, such as oil-containing body fluids in the form of perspiration. “Moisture vapor transmission” is used to describe the passage of water vapor through a structure, such as composite membrane 12. The term “waterproof” is used to describe that composite membrane structure 12 does not “wet” or “wet out” by a challenge liquid, such as water, and prevents the penetration of a challenge liquid through composite membrane structure 12. The term “wind resistant” is used to describe the ability of composite membrane structure 12 to prevent air penetration above more than about three cubic feet per minute (CFM) per square foot at a differential pressure drop 0.5 inches of water but has some air permeability to provide enhanced comfort to someone wearing the laminated fabric. “Air permeable” is used to describe the ability of composite membrane structure 12 to permit a relatively small amount, for example, less than about three CFM per square foot, of air to pass through it. The term “oleophobic” is used to describe a material that is resistant to contamination from absorbing oils, greases, soap, detergent or body fluids, such as perspiration.

Composite membrane structure 12 includes an untreated or unmodified hydrophobic membrane 16 that is porous, and preferably microporous, with a three-dimensional matrix or lattice type structure of a plurality of nodes 22 interconnected by a plurality of fibrils 24. Membrane 16 is made from any suitable material, for example, expanded polytetrafluoroethylene (ePTFE) or a PTFE fabric. In one embodiment, the ePTFE has been at least partially sintered. Generally, the size of a fibril 24 that has been at least partially sintered is in the range of about 0.05 micron to about 0.5 micron in diameter taken in a direction normal to the longitudinal extent of fibril 24.

Surfaces of nodes 22 and fibrils 24 define numerous interconnecting pores 26 that extend completely through membrane 16 between opposite major side surfaces of membrane 16 in a tortuous path. In one embodiment, the average size S of pores 26 in membrane 16 is sufficient to be deemed microporous, but any pore size can be used. In one exemplary embodiment, a suitable average size S for pores 26 in membrane 16 is about 0.01 microns to about 10 microns, and in another embodiment about 0.1 microns to about 5.0 microns.

Membrane 16, in one exemplary embodiment, is made by extruding a mixture of polytetrafluoroethylene (PTFE) fine powder particles (available from DuPont under the name TEFLON® fine powder resin) and lubricant. The extrudate is then calendared. The calendared extrudate is then “expanded” or stretched in at least one and preferably two directions to form fibrils 24 connecting nodes 22 in a three-dimensional matrix or lattice type of structure. “Expanded” is intended to mean sufficiently stretched beyond the elastic limit of the material to introduce permanent set or elongation to fibrils 24. Membrane 16, in one exemplary embodiment, is heated or “sintered” to reduce and minimize residual stress in the ePTFE material. However, in alternate embodiments, membrane 16 is unsintered or partially sintered as is appropriate for the contemplated use of membrane 16.

Other materials and methods can be used to form a suitable membrane 16 that has an open pore structure. For example, other suitable materials include, but are not limited to, polyolefin, polyamide, polyester, polysulfone, polyether, acrylic and methacrylic polymers, polystyrene, polyurethane, polypropylene, polyethylene, cellulosic polymer and combinations thereof. Other suitable methods of making a porous membrane include foaming, skiving or casting any of the suitable materials.

It is known that ePTFE, while having excellent hydrophobic properties, is not oleophilic. That is, the ePTFE making up membrane 16 is susceptible to contamination by absorbing oil. Once this occurs the oil contaminated regions of membrane 16 are considered as “fouled” because the pores 26 can be easily wet by a challenge liquid, such as water, and the membrane is no longer considered waterproof Liquid penetration resistance of a fouled membrane 16 may be lost if a challenge fluid or liquid can “wet” the membrane. Membrane 16 is normally hydrophobic but loses its liquid penetration resistance when the challenge liquid initially contacts and wets a major side of the membrane and subsequently contacts and wets the surfaces defining pores 26 in membrane 16. Progressive wetting of the surfaces defining interconnecting pores 26 occurs until the opposite major side of bases membrane 16 is reached by the wetting or challenge liquid. If the challenge liquid cannot wet the membrane 16, liquid penetration resistance is retained.

FIG. 2 is an enlarged schematic sectional view of a portion of composite membrane structure 12 illustrating a coating layer 28 formed on membrane 16. Coating layer 28 is an oleophobic coating that may enhance oleophobic and hydrophobic properties of membrane 16 without compromising air permeability of membrane 16. For example, coating layer 28 may reduce the surface energy of membrane 16 so fewer oils and oily contaminants are capable of wetting membrane 16 and entering pores 26. Moreover, coating layer 28 may increase the contact angle for oils and/or oily contaminants relative to membrane 16. Coating layer 28 includes coalesced oleophobic fluoropolymer solids. Although coating layer 28 may include other fluoropolymer materials, in some embodiments coating layer 28 is formed from a coating composition including a fluoropolymer that includes an acrylic-based polymer with fluorocarbon side chains. The side chains have been found to have a relatively low surface tension, so it is desirable to extend these away from membrane 16. For example, the oleophobic fluoropolymer used in coating layer 28 are, in some embodiments, in the form of a stabilized water-miscible dispersion of perfluoro alkyl acrylic copolymer and/or perfluoro alkyl methacrylic copolymer solids, such as, but not limited to, water-based dispersions of Zonyl® 8195, 7040, 8412, and/or 8300, available from E.I. DuPont de Nemours and Company, Wilmington, Del. Other suitable fluoropolymers include, but are not limited to, a fluorinated acrylate, a fluorinated methacrylate, a fluorinated n-alkyl acrylate and a fluorinated n-alkyl methacrylate. In some embodiments, the oleophobic fluoropolymer may also contain relatively small amounts of acetone and ethylene glycol or other water-miscible solvents and surfactants that were used in the polymerization reaction.

The coating composition forming coating layer 28 includes, in one embodiment, an amount of the oleophobic fluoropolymer in the range of about 0.1 wt % to about 10 wt % based on a total weight of the coating composition. In another embodiment, the coating composition includes an oleophobic fluoropolymer in the range of about 0.5 wt % to about 1.5 wt %. Although the coating composition may include other amounts of solvent, other than water, in some embodiments, the coating composition that forms coating layer 28 includes an amount of solvent, other than water, in the range of about 40 wt % to about 80 wt %. For example, in some embodiments the coating composition includes an amount of solvent, other than water, in the range of about 50 wt % to about 75 wt %. Although the coating composition may include other amounts of stabilizing agent, in some embodiments the coating composition forming coating layer 28 includes an amount of stabilizing agent in the range of about 5 wt % to 50 wt %. For example, in some embodiments the coating composition includes an amount of stabilizing agent in the range of about 15 wt % to about 25 wt %.

The coating composition forming coating layer 28 has a surface tension and a relative contact angle that enable the coating composition to wet pores 26 in membrane 16 such that pores 26 are coated with the oleophobic fluoropolymer solids in the coating composition. However, in some embodiments membrane 16 is wet with a solution containing a solvent before the coating composition is applied to membrane 16 such that the coating composition will pass through membrane pores 26 and “wet-out” surfaces of membrane 16. In some embodiments, a stabilizing agent and/or solvent is used to dilute a dispersion of oleophobic fluoropolymer solids to a predetermined solids content. It may be desirable to increase a ratio of the stabilizing agent to solvent to increase the stability of the coating composition. However, enough solvent must be present to ensure wetting of membrane 16 and flow of the coating composition into membrane pores 26.

The coating composition is applied to membrane 16 such that substantially all of the surfaces of the nodes 22 and fibrils 24 are at least partially wetted and membrane pores 26 are not blocked. The coating composition adheres and conforms to the surfaces of nodes 22 and fibrils 24 that define membrane pores 26. It is not necessary that the coating composition completely encapsulate the entire surface of a node 22 or fibril 24 or be continuous to increase oleophobicity of membrane 16. The coating composition is then cured by heating membrane 16 such that the oleophobic fluoropolymer flows and coalesce, and such that the stabilizing agents and solvents are removed. During the application of heat, the thermal mobility of the oleophobic fluoropolymer allows the fluoropolymer to be mobile and flow around, engage, and adhere to the surfaces of, nodes 22 and fibrils 24, and therefore coalesce to form coating layer 28. At the relatively elevated temperature, the mobility of the oleophobic fluoropolymer also permits the fluorocarbon side chains to orient themselves to extend in a direction away from the surface of nodes 22 and fibrils 24.

Coating 28 adheres and conforms to the surfaces of nodes 22 and fibrils 24 that define pores 26 in membrane 16. Coating 28 improves or modifies the oleophobicity of the material of membrane 16 to resist contamination from absorbing of contaminating materials such as oils, body oils in perspiration, fatty substances, soap, detergent-like surfactants and other contaminating agents. Also, composite membrane structure 12 remains durably liquid penetration resistant when subjected to rubbing, touching, folding, flexing, abrasive contact or laundering.

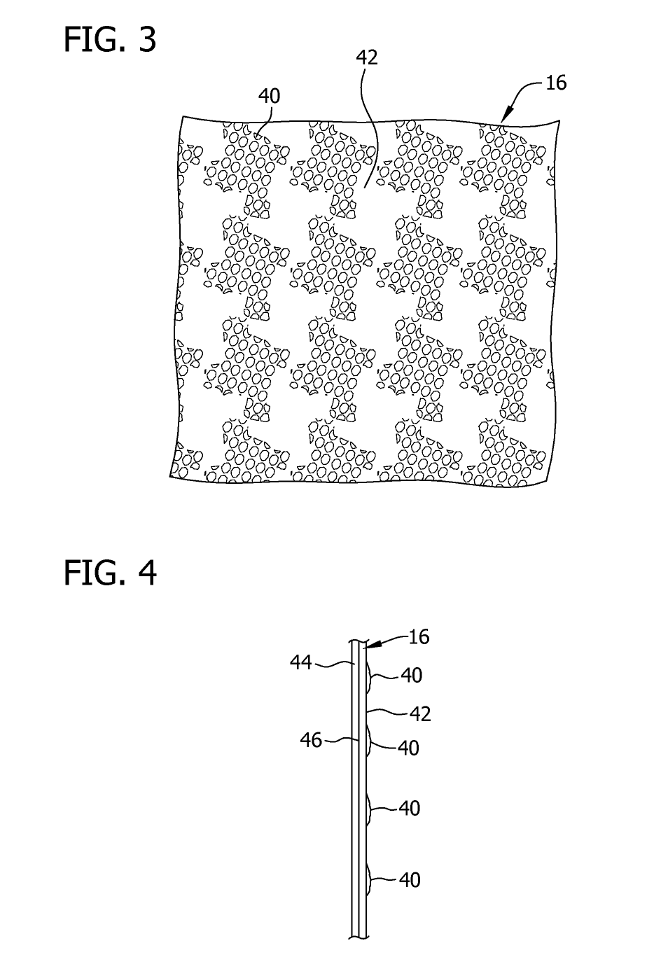

FIG. 3 is an enlarged view of a discontinuous patterned layer 40 formed from a plurality of particles and a polymeric binder applied to a first side 42 of membrane 16. In one exemplary embodiment, patterned layer 40 is printed onto first side 42 by known printing processes, for example, but not limited to, xerographic printing, flexographic printing, gravure-screen printing and combinations thereof.

Particles used to form patterned layer 40 are chosen to provide specific functionality to composite membrane structure 12 depending on its end use, for example, abrasion resistance, surface chemical adsorption, aesthetic properties, and touch-and-feel characteristics. Suitable particles include, but not limited to, titanium oxide particles, zirconium dioxide particles, zinc oxide particles, carbon particles, activated carbon particles, and mixtures thereof. In the exemplary embodiment, the particles are dispersed in a polymeric binder to promote attachment of the particles to membrane 16. Suitable polymeric binders include, but not limited to, polyurethane polymers, cellulosic polymers, polyacrylate polymers, polyalcohol polymers, polyglycol polymers, and mixtures thereof. The polymeric binders are cured after deposition onto membrane 16. The curing temperature will vary depending on the polymeric binder used. In one embodiment, the polymeric binders are cured at a temperature ranging from about 80° C. to about 180° C., in another embodiment, from 100° C. to about 150° C.

Referring also to FIG. 4, a fabric layer 44 may be laminated to a second side 46 of membrane 16. The combination of fabric layer 44 and membrane 16 may be used to form garments. The oleophobic and printed membrane 16 may be used to eliminate the need of a liner/backer layer for different apparel applications, for example, 2-layer unlined jackets, pants, and shirts. Fabric layer 44 may be formed from a woven, nonwoven, or knitted fabric constructed from fibers formed from at least one of polyamids, polyesters, polyolefins, thermoplastic polyurethanes, elastomers, polyetherimides, liquid crystal polymers, polyphenyl ethers, polyphenylene sulfides, cotton, and aramids.

Composite membrane structure 12 described above has a combination of desired functionalities including air permeable, waterproof, breathable, oleophobic, and enhanced durability properties. The combination of functionalities described are not present in an untreated ePTFE membrane without a printed layer of particles. The enhanced durability properties of composite membrane structure 12 include abrasion resistance, surface chemical adsorption, aesthetic properties, and touch-and-feel characteristics. Composite membrane structure 12 may be used for unlined apparel applications where membrane 16, coated with an oleophobic coating and having a printed layer of particles provide waterproof properties, breathability properties, air permeability, oil contamination resistance properties, and abrasion durability.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of making a membrane structure comprising:
providing an air permeable hydrophobic membrane having a first side and a second side;
coating the membrane with a fluoropolymer to impart oleophobic properties to the membrane; and
printing a patterned layer of particles onto the first side of the membrane.

2. The method in accordance with claim 1, wherein printing a patterned layer of particles comprises printing a patterned layer of particles onto the first side of the membrane by at least one of xerographic printing, flexographic printing, and gravure-screen printing.

3. The method in accordance with claim 1, wherein the patterned layer of particles comprise at least one of titanium oxide particles, zirconium dioxide particles, zinc oxide particles, carbon particles, and activated carbon particles.

4. The method in accordance with claim 1, wherein the patterned layer of particles further comprise a polymeric binder.

5. The method in accordance with claim 4, wherein the polymeric binder comprises at least one of polyurethane polymers, cellulosic polymers, polyacrylate polymers, polyalcohol polymers, and polyglycol polymers.

6. The method in accordance with claim 1, further comprising laminating a fabric layer onto the second side of the membrane.

7. The method in accordance with claim 1, wherein the fluoropolymer comprises an acrylic based polymer with fluorocarbon side chains.

8. The method in accordance with claim 1, wherein the membrane comprises at least one of polyolefin, polyamide, polyester, polysulfone, polyether, acrylic, methacrylic, polystyrene, polyurethane, polypropylene, polyethylene, expanded polytetrafluoroethylene (ePTFE), woven PTFE, and non-woven PTFE.

9. A membrane structure comprising:
an air permeable hydrophobic membrane having a first side and a second side;
a coating applied to the surfaces of said membrane, said coating comprising a fluoropolymer having oleophobic properties; and
a patterned layer of particles applied onto said first side of said membrane.

10. The membrane structure in accordance with claim 9, wherein said patterned layer of particles is applied onto said first side of said membrane by at least one of xerographic printing, flexographic printing, and gravure-screen printing.

11. The membrane structure in accordance with claim 9, wherein said patterned layer of particles comprise at least one of titanium oxide particles, zirconium dioxide particles, zinc oxide particles, carbon particles, and activated carbon particles.

12. The membrane structure in accordance with claim 9, wherein said patterned layer of particles further comprise a polymeric binder.

13. The membrane structure in accordance with claim 12, wherein said polymeric binder comprises at least one of polyurethane polymers, cellulosic polymers, polyacrylate polymers, polyalcohol polymers, and polyglycol polymers.

14. The membrane structure in accordance with claim 9, further comprising a fabric layer laminated onto said second side of said membrane.

15. The membrane structure in accordance with claim 9, wherein said fluoropolymer comprises an acrylic based polymer with fluorocarbon side chains.

16. The membrane structure in accordance with claim 9, wherein said membrane comprises at least one of polyolefin, polyamide, polyester, polysulfone, polyether, acrylic, methacrylic, polystyrene, polyurethane, polypropylene, polyethylene, expanded polytetrafluoroethylene (ePTFE), woven PTFE, and non-woven PTFE.

17. A garment comprising a first layer and a second layer, said first layer comprising a fabric, said second layer comprising:
an air permeable hydrophobic membrane having a first side and a second side;
a coating applied to the surfaces of said membrane, said coating comprising a fluoropolymer having oleophobic properties; and
a patterned layer of particles printed onto said first side of said membrane.

18. The garment in accordance with claim 17, wherein said patterned layer of particles comprise at least one of titanium oxide particles, zirconium dioxide particles, zinc oxide particles, carbon particles, and activated carbon particles.

19. The garment in accordance with claim 17, wherein said patterned layer of particles further comprise a polymeric binder, said polymeric binder comprising at least one of polyurethane polymers, cellulosic polymers, polyacrylate polymers, polyalcohol polymers, and polyglycol polymers.

20. The garment in accordance with claim 17, wherein said fluoropolymer comprises an acrylic based polymer with fluorocarbon side chains.
